(19) United States
(12) Patent Application Publication
(10) Pub. No.: US 2006/0250664 A1
(43) Pub. Date: Nov. 9, 2006

(54) Adjustable contact image sensor scanner and adjustment method for the same

(75) Inventor: Hsintang Chien, Taipei (TW)

Correspondence Address: SILICON VALLEY PATENT GROUP LLP, 2350 MISSION COLLEGE BOULEVARD, SUITE 360, SANTA CLARA, CA, 95054, US

(73) Assignee: LITE-ON TECHNOLOGY CORP., Taipei (TW)

(21) Appl. No.: 11/399,562

(22) Filed: Apr. 5, 2006

(30) Foreign Application Priority Data
May 9, 2005 (CN) 200510070457.0

(51) Int. Cl. H04N 1/04

(52) U.S. Cl. 358/474

(57) ABSTRACT

An adjustable contact image sensor (CIS) scanner and an adjustment method therefor are provided. The provided CIS scanner includes a contact image sensor for scanning a desired object and a linkage system connected thereto for adjusting a distance between the contact image sensor and the desired object. The provided CIS scanner is suitable for various applications since the position of the contact image sensor therein is adjustable with the linkage system. In comparison with the conventional CIS scanner, the present invention not only improves the property of the scan image, but also overcomes the drawback resulting from the limited depth of field in the conventional one.

### FIELD OF THE INVENTION

The present invention relates to a focal length adjustable scanning device and the adjustment method therefor, and more particularly to a focal length adjustable contact image sensor (CIS) scanning device and the adjustment method therefore.

### BACKGROUND OF THE INVENTION

Nowadays, the scanning devices on the market include the charge coupled device (CCD) type scanning devices and the contact image sensor (CIS) type scanning devices, which are classified according to the sensor adopted therefor. Typically, the CCD type scanning device is advantageous in showing a superior image resolution and a relatively larger depth of field. Nevertheless, such a scanning device is configured by the combination of optical lenses, which may result in a limitation in miniaturization, a time-consuming in fabrication and a complexity in adjustment.

By contrast, the CIS type scanning device owns a simplified configuration and an ordinary working principle. Because of needing no lamps or optical lenses arrangement, the CIS type scanning device may exhibit a superior ability in anti-vibration. In addition, such a simplified configuration makes the CIS type scanning device further beneficial to be miniaturized. Typically, only the image located above or below the focus of the CIS type scanning device within a range of 0.2 mm could be imaged on the sensor thereof since the depth field thereof is relatively reduced. A relatively larger distance between the object to be scanned and the sensor resulting from the different thickness and position thereof, which falls out of the range of a predetermined focal length thereof, would causes an obscure image for the object to be scanned and an inverse effect for the image quality.

With reference to FIG. 1, which is a diagram showing a conventional adjustable CIS scanning device in accordance with the prior art, the scanning device 1 employs an elastic means 10 for supporting the CIS sensor 11 configured therein. By means of exerting the elastic force produced by the elastic means 10, the CIS sensor 11 comes in contact with the glass plate 12 located thereabove, and thereby the position of the CIS sensor 11 is controllable and rubs against the glass plate 12 for performing the scanning operation.

Please refer to FIG. 2, which is a diagram showing a further conventional adjustable CIS scanning device in accordance with the prior art. The scanning device 2 includes an adjustable holder 20 for receiving the sensor (not shown). The adjustable holder 20 is movable in the direction for scanning by means of the sliding elements 22 and 23 that are arranged on the opposite sides thereof and the transmission belt 26. The transmission belt 26 is provided with a driving force by a motor (not shown), so that the sliding elements 22 and 23 are driven to move and guide the movement of the adjustable holder 20. Moreover, the screw 21 propped and configured on the bottom of the adjustable holder 20 serves for pushing the adjustable holder 20, and the adjustable holder 20 as well as the CIS sensor received therein may move up and down thereby, so as to adjust the position of the CIS sensor.

Nevertheless, both of the mentioned adjustable scanning devices are configured and developed for a single application. That is, the mentioned adjustable scanning devices only work and suit for a certain kind of object to be scanned. Furthermore, though the elastic force produced by the elastic means, e.g. springs or elastic tapes, is adoptable for adjusting the distance between the sensor and the object to be scanned in response to the thickness and the position thereof while scanning, the mentioned adjustable scanning device is still disadvantageous in the relatively poor image quality obtained therefrom. This is because the CIS sensor would contact and rub against the glass plate located thereabove while scanning, not only causing a poor quality for the scanned image, but also resulting in a power-consuming for the torque consumption by friction. In addition, the focus adjustment by means of adjusting the screw as mentioned is only achievable by a manual operation, which may result in a decrement in operation efficiency and a poor image quality owing to an artificial misoperation.

For overcoming the mentioned drawbacks caused by the conventional adjustable scanning device, a novel adjustable contact image sensor (CIS) scanner and the adjustment method therefore are provided in the present invention, and thereby the distance between the object to be scanned and the CIS sensor configured in the scanner is precisely adjustable, so as to obtain a distinctive scanned image with a relatively high quality.

### SUMMARY OF THE INVENTION

The present invention provides a novel adjustable contact image sensor (CIS) scanner, and thereby the distance between the object to be scanned and the CIS sensor configured in the scanner is precisely adjustable.

The present invention also provides a novel adjustable CIS scanner, by which a distinctive scanned image with a relatively high quality is obtained.

The present invention further provides an adjustment method for adjusting the distance between the object to be scanned and the CIS sensor configured in the scanner, so as to obtain a distinctive scanned image with a relatively high quality.

In accordance with a first aspect of the present invention, the provided adjustable scanning device includes a contact image sensor for scanning an object and a linkage system connected to the contact image sensor for adjusting a distance between the contact image sensor and the object.

Preferably, the adjustable scanning device further includes an actuating device connected to the linkage system for actuating the linkage system.

Preferably, the actuating device is one selected from a group consisting of a motor device, a solenoid device and a mechanical actuating device.

Preferably, the adjustable scanning device further includes a scanning glass having a marking element thereon as a reference mark for the distance.

Preferably, the adjustable scanning device further includes an adjusting device configured on the contact image sensor for adjusting the distance.

Preferably, the adjusting device includes a first elastic element.

Preferably, the adjustable scanning device further includes a housing for containing the contact image sensor and the linkage system therein.

Preferably, the adjustable scanning device further includes a second elastic element configured between an interior surface of the housing and the contact image sensor.

In accordance with a second aspect of the present invention, the provided adjustable scanning device includes a contact image sensor having a focal length for scanning an object, and an adjustment device connected to the contact image sensor for adjusting a position of the contact image sensor in response to the object, so as to obtain a distance between the contact image sensor and the object corresponding to the focal length.

Preferably, the position of the contact image sensor is adjusted in response to one of a thickness and a position of the object.

Preferably, the adjustment device includes a linkage system.

Preferably, the adjustable scanning device further includes at least an actuating device connected to the adjustment device for actuating the adjustment device.

Preferably, the actuating device is one selected from a group consisting of a motor device, a solenoid device and a mechanical actuating device.

Preferably, the adjustable scanning device further includes a scanning glass having a marking element thereon as a reference mark for the distance.

Preferably, the adjustable scanning device further includes an adjusting device configured on the contact image sensor for adjusting one of the position and the distance.

Preferably, the adjusting device includes a first elastic element.

Preferably, the adjustable scanning device further includes a housing for containing the contact image sensor and the linkage system therein.

Preferably, the adjustable scanning device further includes a second elastic element configured between an interior surface of the housing and the contact image sensor.

In accordance with a third aspect of the present invention, a method for adjusting a scanning device having a linkage system and a contact image sensor with a focal length is provided. The method includes steps of (a) determining a first distance between an object and the contact image sensor; (b) comparing the first distance with the focal length to obtain a first result; and (c) actuating the linkage system for adjusting a position of the contact image sensor based on the first result.

Preferably, the first distance is determined in response to one of a thickness and a position of the object in the step (a).

Preferably, the position of the contact image sensor is adjusted to obtain a second distance between the contact image sensor and the object corresponding to the focal length.

Preferably, the method further includes a step of (d) scanning the object so as to form a scanning image.

Preferably, the method further includes steps of (e) determining a second result based on the scanning image; and (f) actuating the linkage system based on the second result.

Preferably, the linkage system is actuated via one of a stepless-typed actuation and a step-typed actuation.

The foregoing and other features and advantages of the present invention will be more clearly understood through the following descriptions with reference to the drawings, wherein:

### BRIEF DESCRIPTION OF THE DRAWINGS

FIG. 1 is a diagram illustrating the structure of a first conventional contact image sensor (CIS) adjustable scanning device according to the prior art;

FIG. 2 is a diagram illustrating the structure of a second conventional CIS adjustable scanning device according to the prior art;

FIGS. 3(A) and 3(B) are diagrams schematically illustrating the appearance and the structure of a CIS adjustable scanning device according to a first preferred embodiment of the present invention;

FIGS. 4(A) and 4(B) are cross-sectional views schematically illustrating the operation of a CIS adjustable scanning device according to a second preferred embodiment of the present invention;

FIG. 5 is a flow chart for illustrating the typical steps of the adjustment method for adjusting a CIS scanning device according to the present invention;

FIG. 6 is a flow chart for illustrating the detailed steps of the adjustment method for adjusting a CIS scanning device according to a first embodiment of the present invention;

FIG. 7 is a flow chart for illustrating the detailed steps of the adjustment method for adjusting a CIS scanning device according to a second embodiment of the present invention;

FIG. 8 is a flow chart for illustrating the detailed steps of the adjustment method for adjusting a CIS scanning device according to a third embodiment of the present invention; and

FIG. 9 is a flow chart for illustrating the detailed steps of the adjustment method for adjusting a CIS scanning device according to a fourth embodiment of the present invention.

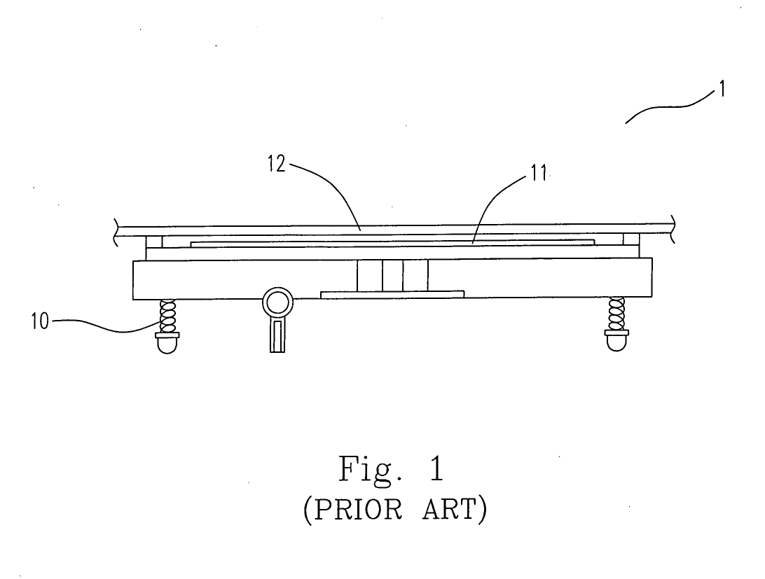

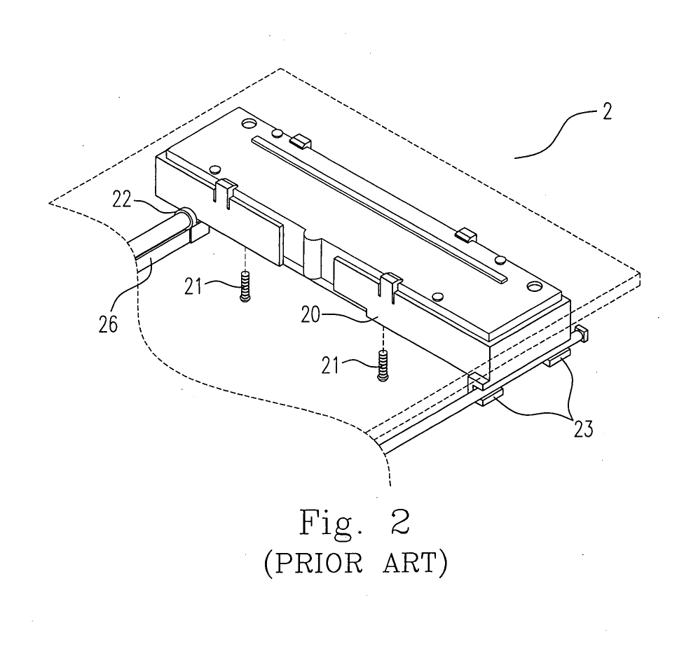

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

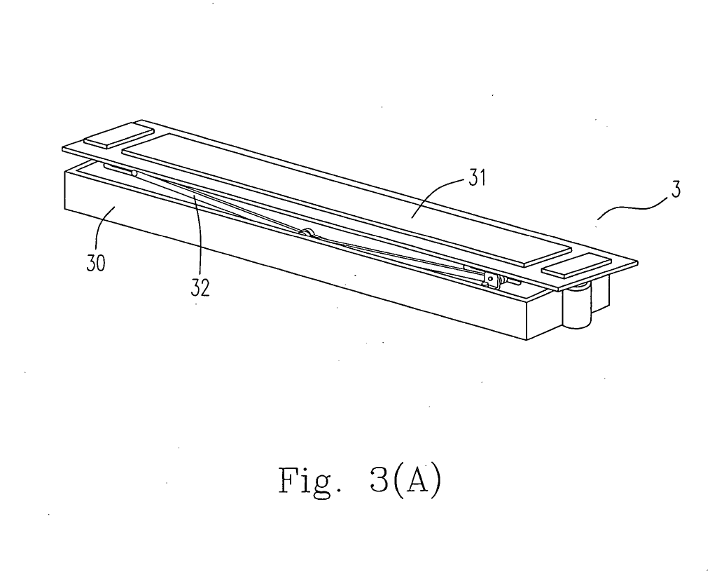

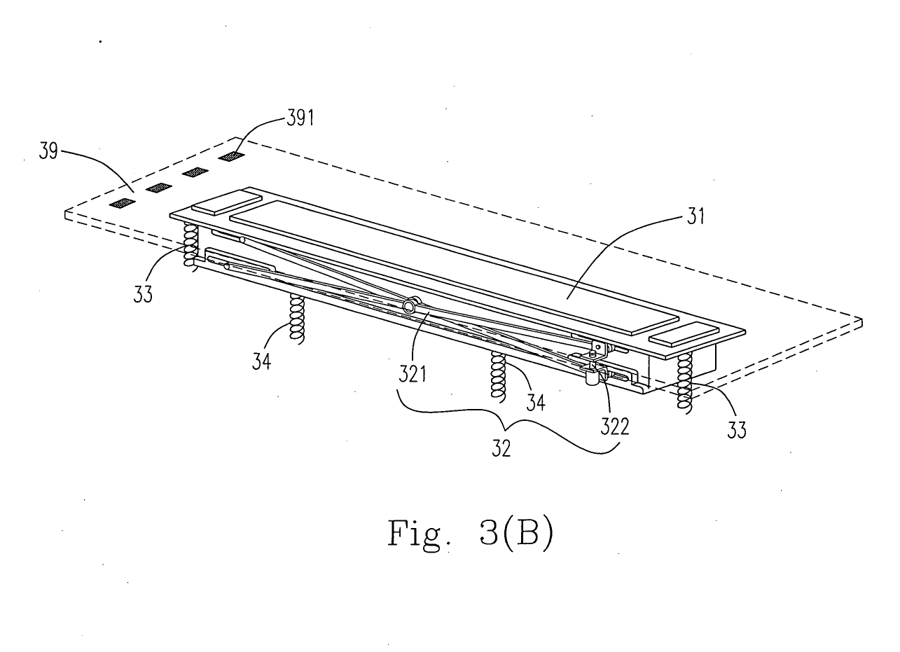

Please refer to FIGS. 3(A) and 3(B), which are respective diagrams schematically illustrating the appearance and the structure of an adjustable scanning device according to a first preferred embodiment of the present invention. The adjustable scanning device 3 includes a contact image sensor (CIS) 31, an adjustment device 32 coupled therewith and a housing 30 for containing the CIS sensor 31 as well as the adjustment device 32 therein for protection. The adjustment device 32 is constructed by a linkage system 321 and an actuating device 322. The linkage system 321 is actuated by the actuating device 322, so as to adjust the height of the CIS sensor 31 in response to the position of the object to be scanned that is arranged on the scanning glass 39. In this case, the distance between the CIS sensor 31 and the object to be scanned is optimized and fall in a predetermined ranged of focal length for the CIS sensor 31, so that the object would be scanned with such optimized distance, and thereby a scanning image with an excellent quality would be obtained.

For further tuning the distance between the CIS sensor 31 and the object to be scanned, in this embodiment, a respective first elastic element 33 is mounted on the opposite sides of the CIS sensor 31. The CIS sensor 31 is also optionally provided with a second elastic element 34 that is configured between the bottom thereof and the interior surface of the housing 30. The respective first and second elastic elements 33 and 34 not only provide an elastic force for tuning the distance between the CIS sensor 31 and the object to be scanned, but also absorbs the vibration produced while adjusting the CIS sensor. Typically, springs, elastic tapes and even the flexible foam materials are adoptable for the elastic elements 33 and 34 according to the present invention.

In this preferred embodiment, a four-bar linkage system is adopted for serving as the linkage system 321 of the adjustment device 32 according to the present invention, so as to fabricate a simplified structure and reduce the production cost therefor. Alternatively, a further complicated linkage system, e.g. the five-bar linkage system, the six-bar linkage system or the like, is also adoptable for constructing the adjustment device 32 in addition to the mentioned four-bar ones.

In this preferred embodiment, the actuating device 322 is a motor which provides a stepless-typed driving force for actuating the linkage system 321. Alternatively, a solenoid device is adoptable for providing a step-typed driving force so as to actuate the linkage system 321, or a simple mechanical device such as a cam, an eccentric screw or an elastic element, is also adopted therefor, depending on an actual demand in application.

Moreover, the scanning glass 39 is provided with a marking element 391, which is configured thereon and serves as a reference pattern while the distance between the CIS sensor 31 and the object to be scanned is adjusted by the adjustment device 32. Certainly, in the case of automatic document feeder (ADF) scanning, the marking element is also configurable on the automatic document feeder.

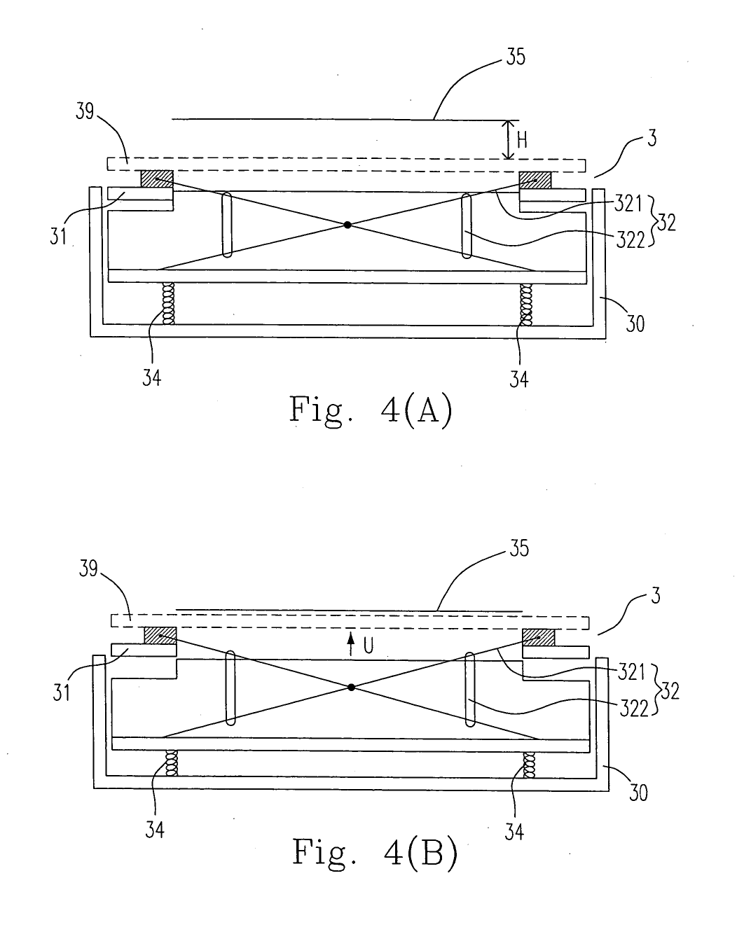

Please refer to FIGS. 4(A) and 4(B), which are cross-sectional views schematically illustrating the operation of the adjustable scanning device according to a second preferred embodiment of the present invention. In this preferred embodiment, the adjustment device 32 of the adjustable scanning device 3 is constructed by a linkage system 321 and two actuating devices 322, so as to keep the balance for the linkage system 321 while it acts. When the distance H between the object to be scanned 35 and the scanning glass 39 of the adjustable scanning device 3 is larger than the predetermined focal length of the adjustable scanning device 3 owing to the thickness or the position of the object to be scanned 35, the scanning image obtained therefrom would be obscure, as shown in FIG. 4(A). For obtaining a clear scanning image, the actuating devices 322 serve for actuating the linkage system 321 in response to the distance H. The upper portion of the linkage system 321 is connected to the CIS sensor 31, and thereby the CIS sensor is moved upwardly, as indicated by the direction U in FIG. 4(B), so as to reduce the distance between the object to be scanned 35 and the scanning glass 39. On the other hand, the lower portion of the linkage system 321 serves for exerting a force to the elastic element 34 which is connected to the bottom of the CIS sensor 31, so that an elastic force is produced by the elastic element 34 in response thereto, and thereby the distance between the object to be scanned 35 and the CIS sensor 31 is tunable and the vibration generated by the linkage system 321 while adjusting the CIS sensor 31 is also prevented.

By means of the adjustable scanning device according to the present invention, the drawback regarding the limitation for the depth of field of the conventional adjustable scanning device is overcome. According to the present invention, the height of the CIS sensor is adjusted depending on the respective demands for the different scanning applications, and thus the distance between the CIS sensor and the object to be scanned would be adjusted as well, so as to obtain a scanning image with an optimized quality.

Furthermore, the present invention also provides a method for adjusting the height of the CIS sensing device, so as to adjust the distance between the object to be scanned and the CIS sensor for obtaining an improved scanning image.

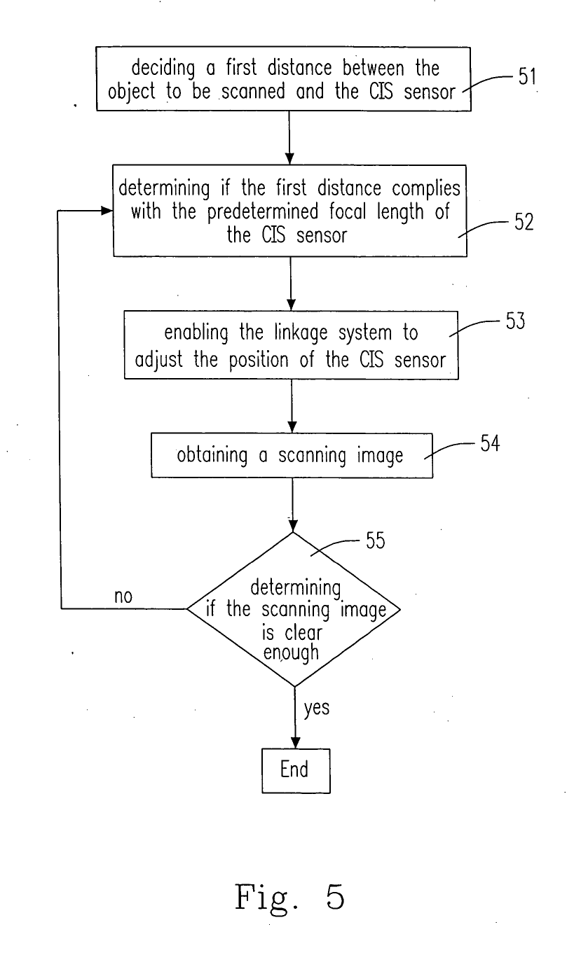

Please refer to FIG. 5, which is a flow chart for illustrating the typical steps of the adjustment method for adjusting a scanning device according to the present invention, where the scanning device includes a CIS sensor and a linkage system serving as the adjustment device. First, an object to be scanned is decided, and a first distance between the selected object to be scanned and the CIS sensor is determined, as shown in the step 51. The determined first distance is compared with a predetermined focal length of the CIS sensor, so as to determine if the first distance complies with the focal length of the CIS sensor, as show in the step 52. If this is not the case, the linkage system of the scanning device will be enabled, so as to adjust the CIS sensor to a position where a second distance between the object to be scanned and the CIS sensor, in response to the focal length, is determined, as shown in the step 53. Finally, the scanning is performed and a scanning image is thus obtained, as shown in the step 54.

In the present method, the first distance is determined based on the thickness or the position of the object to be scanned. In addition, for further improving the quality of the obtained scanning image, it is feasible to determine based on the scanning image obtained from the first scan if the linkage system needs to be enabled again for re-adjusting the position of CIS sensor, as shown in the step 55.

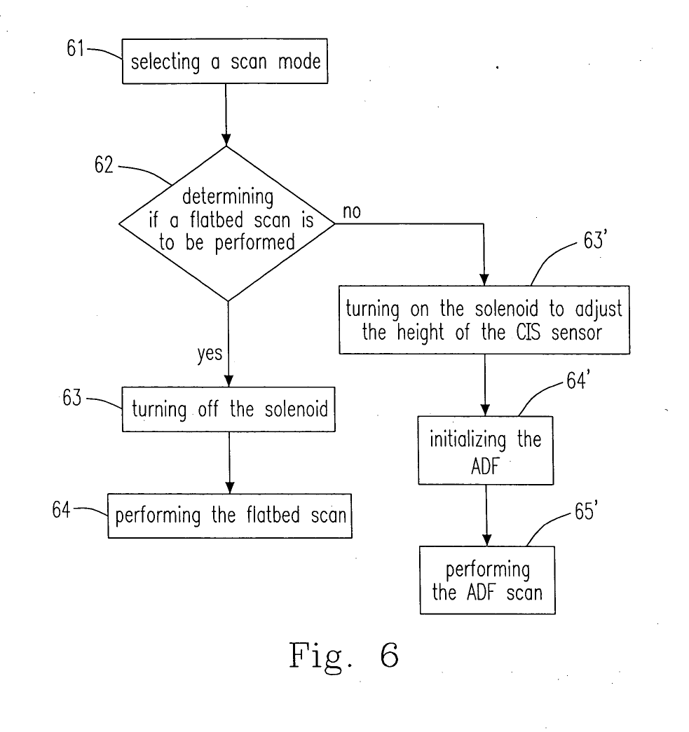

The mentioned steps are incorporated into the scan procedures of the scanning device according to the present invention, so that a series of procedures would be provided for manual operation, and alternatively, would be programmed as a procedure for automatic operation, as shown in FIGS. 6 to 9.

Please refer to FIG. 6, which is a flow chart for illustrating the detailed steps of the adjustment method for adjusting a scanning device according to a first embodiment of the present invention. In this preferred embodiment, such method relates to a step-typed adjustment method. In this case, the adjustment device includes a CIS sensor and a linkage system where the linkage system includes a solenoid actuating device therein, so as to provide a step-typed driving force for actuating the linkage system. In this method, a scan mode, e.g. a positive film scan mode, is decided depending on an actual demand, as shown in the step 61. It needs to determine if a flatbed scan is to be performed, as shown in the step 62. If the flatbed scan is to be performed, the solenoid device would be turned off and then the flatbed scan is performed, as shown in the steps 63 and 64, respectively. Alternatively, if the flatbed scan is not to be performed, the solenoid device would be turned on and the linkage system would be actuated by the driving force provided thereby, so as to adjust the height of the CIS sensor, as shown in the step 63′. Subsequently, the automatic document feeder (ADF) configured in the scanning device would be initialized, and the ADF scan mode is performed, as shown in the steps 64′ and 65′, respectively.

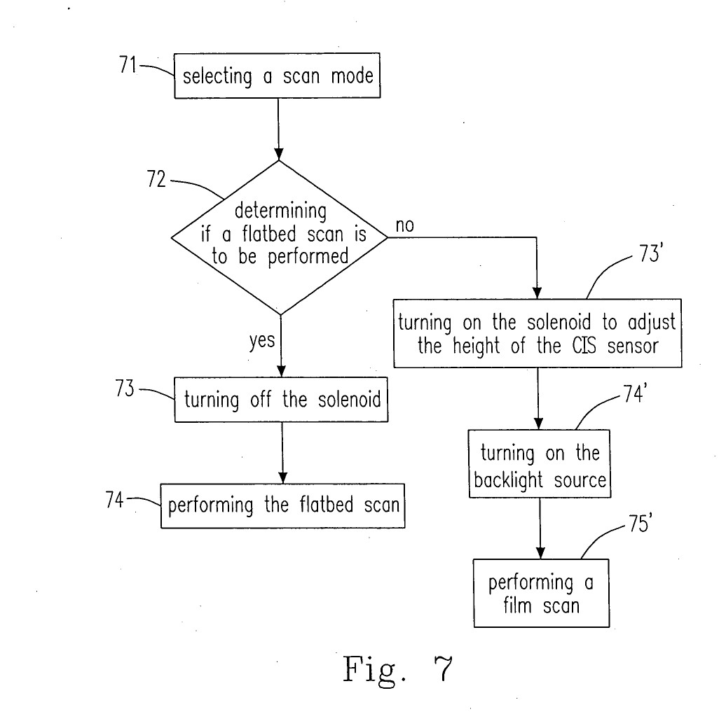

Please refer to FIG. 7, which is a flow chart for illustrating the detailed steps of the adjustment method for adjusting a scanning device according to a second embodiment of the present invention. In this case, a film scan mode is decided depending on an actual demand, as shown in the step 71. Also, it needs to determine if a flatbed scan is to be performed, as shown in the step 72. If the flatbed scan is to be performed, the solenoid device would be turned off and then the flatbed scan is performed, as shown in the steps 73 and 74, respectively. Alternatively, if the flatbed scan is not to be performed, the solenoid device would be turned on and the linkage system would be actuated by the driving force provided thereby, so as to adjust the height of the CIS sensor, as shown in the step 73′. Subsequently, the backlight source configured in the scanning device would be turned on, and the film scan mode is performed, as shown in the steps 74′ and 75′, respectively.

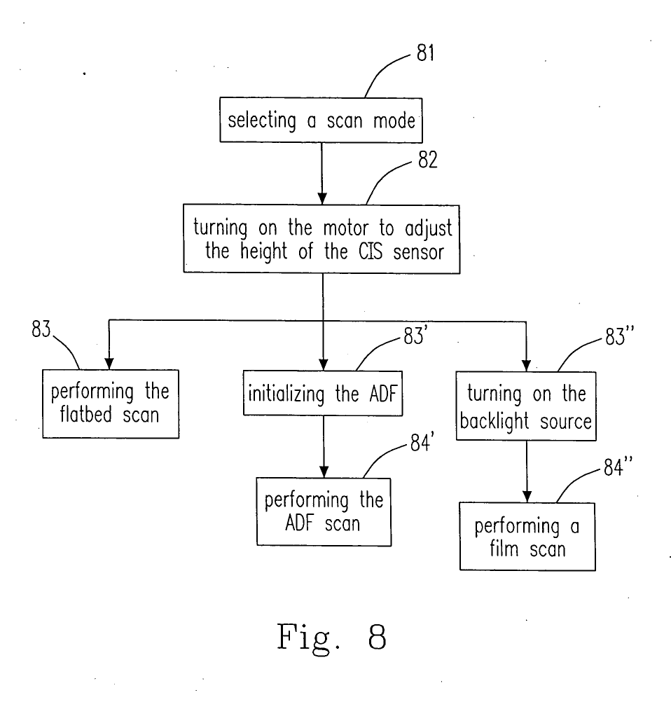

Please refer to FIG. 8, which is a flow chart for illustrating the detailed steps of the adjustment method for adjusting a scanning device according to a third embodiment of the present invention. In this preferred embodiment, such method relates to a stepless-typed adjustment method, and the adjustment device includes a CIS sensor and a linkage system where the linkage system includes a motor device therein, so as to provide a stepless-typed driving force for actuating the linkage system. In this method, a scan mode, e.g. a flatbed scan mode, an ADF scan mode or a film scan mode, is decided depending on an actual demand, as shown in the step 81. It is supposed that the thickness and the position of the object to be scanned in the respective scan mode is known, i.e. the operation of the motor device for adjusting the distance between the object to be scanned and the CIS sensor to comply with the predetermined focal length of the CIS sensor is determined, therefore the motor device could be turned on before scanning, so as to actuate the linkage system to move the CIS sensor to an optimized position where the distance between the object to be scanned and the CIS sensor complies with the focal length thereof, as shown in the step 82. Then, the scanning is performed under the decided scan mode. According to the present invention, if the flatbed scan mode is decided, then the flatbed scan would be performed directly, as shown in the step 83. If the ADF scan mode is decided, then the automatic document feeder configured in the scanning device would be initialized for performing the ADF scan, as shown in the steps 83′ and 84′, respectively. Nevertheless, if the film scan mode is decided, the backlight source configured in the scanning device would be turned on, and then the film scan would be performed, as shown in the steps 83″ and 84″, respectively.

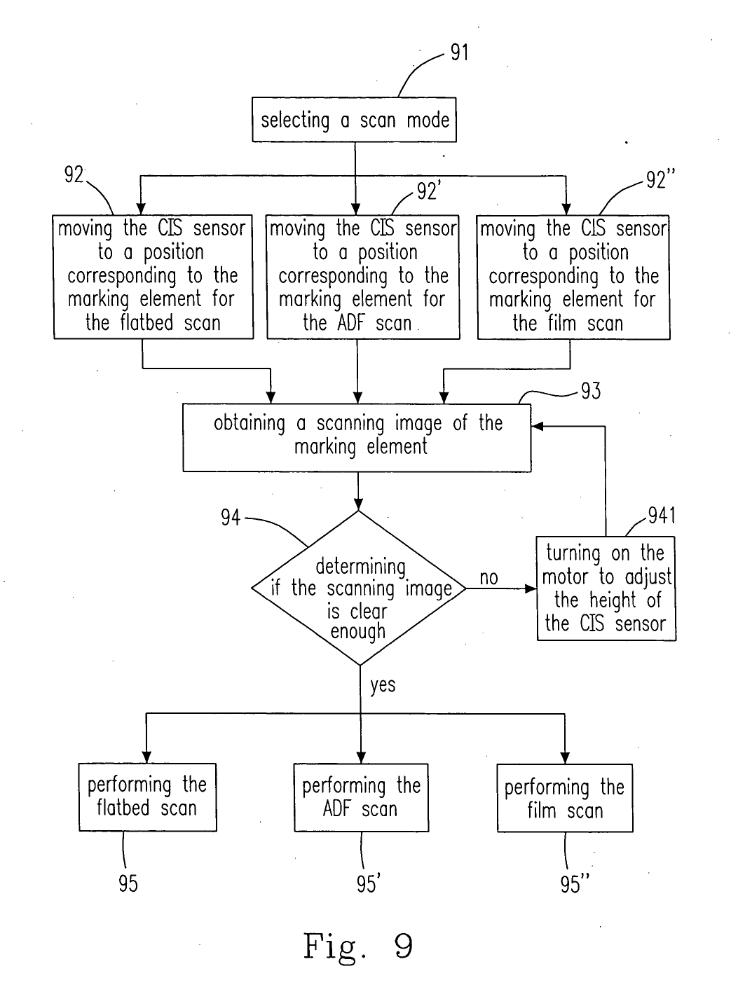

Please refer to FIG. 9, which is a flow chart for illustrating the detailed steps of the adjustment method for adjusting a scanning device according to a fourth embodiment of the present invention. In this preferred embodiment, such method relates to a stepless-typed adjustment method, and the adjustment device includes a CIS sensor and a linkage system where the linkage system includes a motor device therein, so as to provide a stepless-typed driving force for actuating the linkage system. Moreover, the present scanning device is advantageous in a plurality of marking elements configured therein, for serving as the reference pattern for adjusting the distance between the object to be scanned and the CIS sensor. In this method, a scan mode, e.g. a flatbed scan mode, an ADF scan mode or a film scan mode, is decided depending on an actual demand, as shown in the step 91. Then the CIS sensor is moved based on the decided scan mode, so as to be moved to a position corresponding to the marking element for the flatbed scan (step 92), a position corresponding to the marking element for the ADF scan (step 92′), and a position corresponding to the marking element for the film scan (step 92″), respectively. The scan is performed under the decided scan mode, so as to obtain a scanning image of the respective marking element, as shown in the step 93. Accordingly, it is determined if the obtained scanning image is clear enough, as shown in the step 94.

Based on the determination in the step 94, it is further determined if the CIS sensor needs to be adjusted again. If the scanning image obtained in the step 94 is clear enough, then the flatbed scan, the ADF scan or the film scan would be subsequently performed, as shown in the steps 95, 95′, 95″, respectively. Nevertheless, if the scanning image obtained in the step 94 is considered unclear, the motor device would be turned on to actuate the linkage system, so as to move the CIS sensor to an optimized position where the distance between the object to be scanned and the CIS sensor complies the predetermined focal length, as shown in the step 941, and then the scan for the marking element as shown in the step 93 is performed again. Afterward, the distance between the object to be scanned and the CIS sensor would be thus optimized depending on the actual demand for the respective scan modes, where a scanning image with a high quality is hence achievable.

Based on the mentioned descriptions, the drawback regarding the scanning image with a poor quality resulting from the limitation for depth of field of the conventional CIS scanning device is substantially overcome by the novel adjustable scanning device and the adjustment method therefor according to the present invention. Moreover, by means of the combination of adjustment device and the actuating device, the position of the CIS sensor, and thus the distance between the object to be scanned and the CIS sensor are also adjustable depending on the actual demand for different scan modes, so as to obtain a scanning image of the object to be scanned with an excellent quality. According to the present invention, furthermore, the adjustable scanning device having the marking element configured therein is more advantageous in that the height of the CIS sensor is adjustable corresponding to the scanning image of the marking element before the desired scan is performed, and hence the quality of the scanning image of the object to be scanned would be improved if the scan is performed upon a clear scanning image of the marking element being obtained.

Therefore, the present invention not only has a novelty and a progressive nature, but also has an industry utility.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. An adjustable scanning device, comprising:
a contact image sensor for scanning an object; and
a linkage system connected to said contact image sensor for adjusting a distance between said contact image sensor and said object.

2. The adjustable scanning device according to claim 1, further comprising an actuating device connected to said linkage system for actuating said linkage system.

3. The adjustable scanning device according to claim 2, wherein said actuating device is one selected from a group consisting of a motor device, a solenoid device and a mechanical actuating device.

4. The adjustable scanning device according to claim 1, further comprising a scanning glass having a marking element thereon as a reference mark for said distance.

5. The adjustable scanning device according to claim 1, further comprising an adjusting device configured on said contact image sensor for adjusting said distance.

6. The adjustable scanning device according to claim 5, wherein said adjusting device comprises a first elastic element.

7. The adjustable scanning device according to claim 1, further comprising a housing for containing said contact image sensor and said linkage system therein.

8. The adjustable scanning device according to claim 7, further comprising a second elastic element configured between an interior surface of said housing and said contact image sensor.

9. An adjustable scanning device, comprising:
a contact image sensor having a focal length for scanning an object; and
an adjustment device connected to said contact image sensor for adjusting a position of said contact image sensor in response to said object, so as to obtain a distance between said contact image sensor and said object corresponding to said focal length.

10. The adjustable scanning device according to claim 9, wherein said position of said contact image sensor is adjusted in response to one of a thickness and a position of said object.

11. The adjustable scanning device according to claim 9, wherein said adjustment device comprises a linkage system.

12. The adjustable scanning device according to claim 9, further comprising at least an actuating device connected to said adjustment device for actuating said adjustment device.

13. The adjustable scanning device according to claim 12, wherein said actuating device is one selected from a group consisting of a motor device, a solenoid device and a mechanical actuating device.

14. The adjustable scanning device according to claim 9, further comprising a scanning glass having a marking element thereon as a reference mark for said distance.

15. The adjustable scanning device according to claim 9, further comprising an adjusting device configured on said contact image sensor for adjusting one of said position and said distance.

16. The adjustable scanning device according to claim 15, wherein said adjusting device comprises a first elastic element.

17. The adjustable scanning device according to claim 9, further comprising a housing for containing said contact image sensor and said linkage system therein.

18. The adjustable scanning device according to claim 17, further comprising a second elastic element configured between an interior surface of said housing and said contact image sensor.

19. A method for adjusting a scanning device having a linkage system and a contact image sensor with a focal length, comprising steps of:
(a) determining a first distance between an object and said contact image sensor;
(b) comparing said first distance with said focal length to obtain a first result; and
(c) actuating said linkage system for adjusting a position of said contact image sensor based on said first result.

20. The method according to claim 19, wherein said first distance is determined in response to one of a thickness and a position of said object in the step (a).

21. The method according to claim 19, wherein said position of said contact image sensor is adjusted to obtain a second distance between said contact image sensor and said object corresponding to said focal length in the step (a).

22. The method according to claim 19, after the step (c), further comprising a step of:
(d) scanning said object so as to form a scanning image.

23. The method according to claim 22, after the step (c), further comprising steps of:
(e) determining a second result based on said scanning image; and
(f) actuating said linkage system based on said second result.

24. The method according to claim 19, wherein said linkage system is actuated via one of a stepless-typed actuation and a step-typed actuation.
